(19) United States
(12) Patent Application Publication
(10) Pub. No.: US 2021/0266308 A1
(43) Pub. Date: Aug. 26, 2021

(54) Methods for Delivering an Authenticatable Management Activity to Remote Devices

(71) Applicant: Arm IP Limited, Cambridge (GB)

(72) Inventors: Robert George Taylor, Cambridge (GB); Brendan James Moran, Histon (GB); Milosch Meriac, Cambridge (GB); Geraint David Luff, Cambridge (GB)

(73) Assignee: Arm IP Limited, Cambridge (GB)

(21) Appl. No.: 17/255,087

(22) PCT Filed: May 24, 2019
(86) PCT No.: PCT/GB2019/051436

§ 371 Date: Dec. 22, 2020

(30) Foreign Application Priority Data
Jun. 28, 2018 (GB) 1810674.0

(51) Int. Cl. H04L 29/06; H04L 9/32

(52) U.S. Cl. CPC H04L 63/083; H04L 9/3247

(57) ABSTRACT

Methods for delivering an authenticatable management activity to a group of remote devices in a networked computing environment is described herein. An authenticatable management activity may be any activity which requires internal state changes to be made at a remote device, such as software or firmware updates, system configuration operations, access control list update operations, file transfer operations, changes to user data etc., and which requires an operators approval of the activity before being performed. In addition to an operators approval of the activity, the management activity is required to be signed by an operator, such that the operator authorising the management activity is authenticated.

The present techniques relate to methods for delivering an authenticatable management activity to a group of remote devices. More particularly, the techniques relate to methods for authenticating an operator who authorises a management activity for delivery to a group of remote devices.

In networked computing environments, it is often necessary to perform operations that may be security and/or privacy sensitive, or that may be vulnerable to malicious interference. Therefore, secure user authorisation is desirable. However, secure user authorisation often involves the user being required to download authentication software. In addition, devices which are of reduced size, capacity and complexity, such as the sensors, local controllers and controlled devices of the Internet of Things (IoT), may not have the infrastructure required to install and use security authorisation applications.

According to a first technique, there is provided a computer implemented method for delivering an authenticatable management activity to a group of remote devices. The method comprising: receiving, at a remote web client, an activity authorisation token from a remote service, the activity authorisation token defining a management activity to be performed on the group of remote devices; rendering, at the remote web client, a human-readable description of the management activity to be approved by an operator of the remote client; in response to approval of the management activity by the operator, adding, at the remote web client, a client signature to the activity authorisation token with a remote client private key under the control of the operator; and forwarding, from the remote web client, the signed token via the web service to enable the signed token to be provided to the group of remote devices.

According to a second technique, there is provided a computer implemented method for establishing trust in a remote service. The method comprising: locally storing, at a browser, a static signing web application page targeting the remote service; and executing the signing web page, the signing web page comprising an activity authorisation token defining a management activity provided by the remote service for client authorization to be performed on a group of remote devices.

According to a third technique, there is provided a computer implemented method of controlling a hardware security module to apply a client signature to an activity authorisation token, the activity authorisation token defining a management activity to be performed on a group of remote devices. The method comprising: storing a client private key in the hardware security module; in response to an operator approving of the management activity, requesting the operator provides operator authentication to release the client private key; generating the client signature based on the client private key; and applying the client signature to the activity authorisation token.

According to a fourth technique, there is provided a computer readable storage medium comprising program code for performing the methods described herein.

According to a fifth technique, there is provided an apparatus for performing the methods described herein.

Embodiments will now be described with reference to the accompanying figures of which:

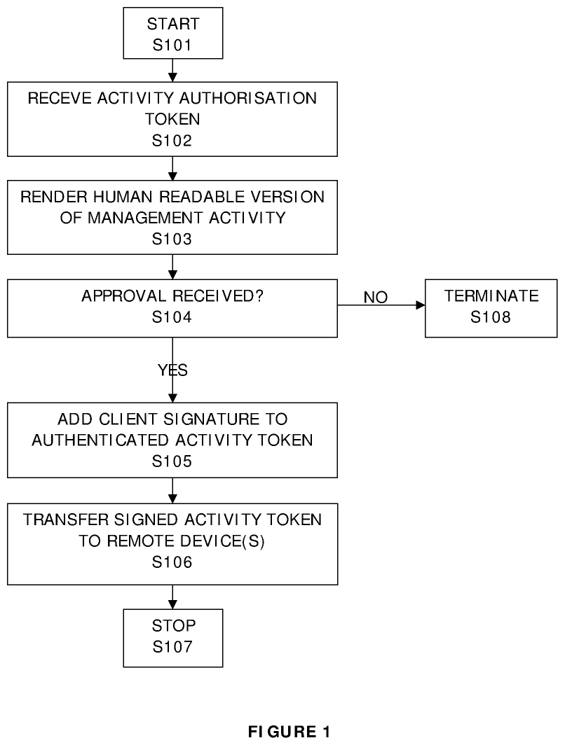

FIG. 1 illustrates schematically a method for delivering an authenticatable management activity to a group of remote devices;

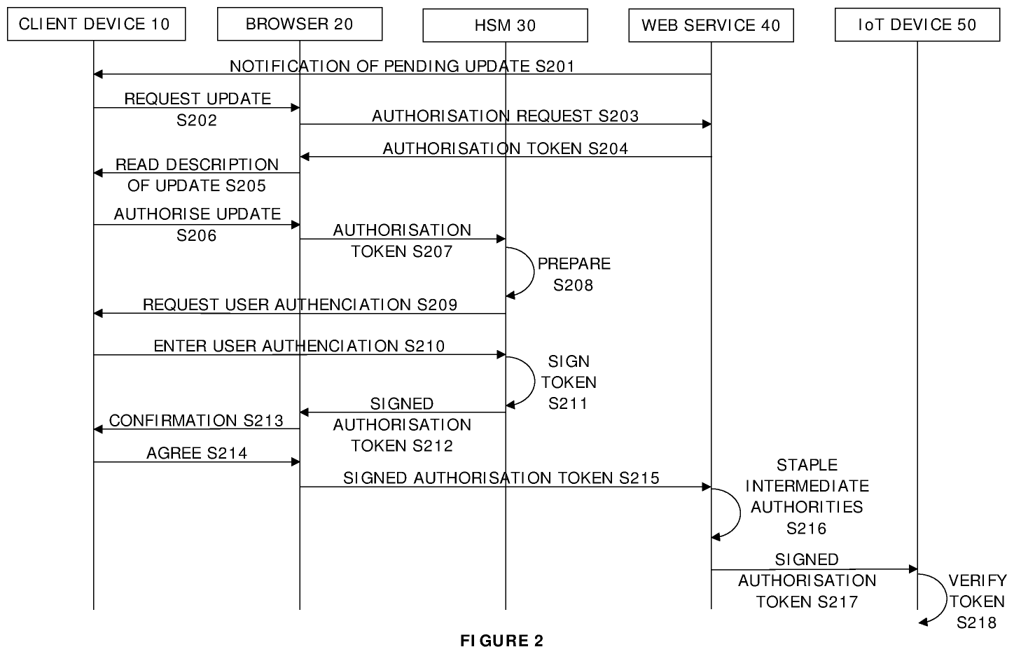

FIG. 2 illustrates schematically a communication flow for authorising and authenticating a management activity which is to be performed at a group of remote IoT devices; and

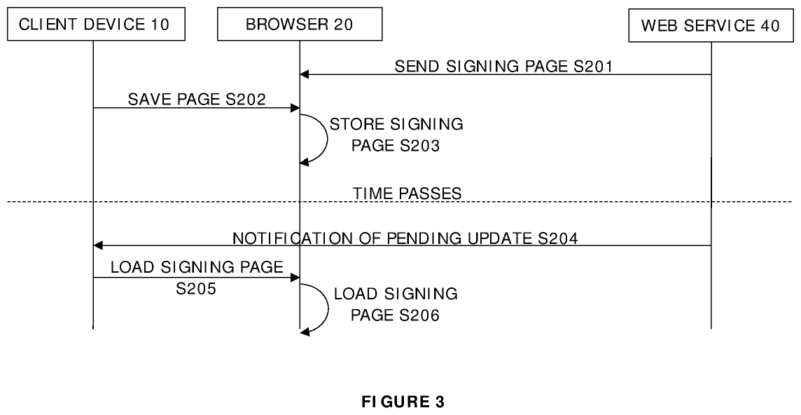

FIG. 3 illustrates schematically a communication flow for saving and utilising a signing web page.

Methods for delivering an authenticatable management activity to a group of remote devices in a networked computing environment are described herein. An authenticatable management activity may be any activity which requires internal state changes to be made at a remote device, such as software or firmware updates, system configuration operations, access control list update operations, file transfer operations, changes to user data etc., and which requires an operators approval of the activity before being performed. In addition to an operators approval of the activity, the management activity is required to be signed by an operator, such that the operator authorising the management activity is authenticated.

A remote device which receives the authenticated management activity may verify that the management activity has been authorised and that the approver has been authenticated prior to execution of the management activity at the remote device.

Such authenticated management activities may help reduce the number of successful malicious attacks at remote devices, since the authentication of the operator confirms that it was a legitimate operator and not a third party which approved the management activity.

In addition, the operator is not required to download additional software at a client device in order to authenticate the management activity and an operator may not need to establish trust of the web service from which the management activity was received.

Reference will now be made in detail to the embodiments, examples of which are illustrated in the accompanying drawings. In the following detailed description numerous specific details are set forth by way of examples in order to provide a thorough understanding of the relevant teachings. However, it will be apparent to one of ordinary skill in the art that the present teachings may be practiced without these specific details.

In other instances, well known methods, procedures, components and/or circuitry have been described at a relatively high-level, without detail, in order to avoid unnecessarily obscuring aspects of the present teachings.

FIG. 1 illustrates a method for delivering an authenticatable management activity to a group of remote devices. A group may be one or more remote devices. The method starts at step S101. At step S102, an authorisation token for a management activity which is to be performed at the group of remote devices is received at a client device. The authorisation token comprises, at least, a digital signature of the web service which issued the authorisation request and machine-readable data. The machine-readable data comprising sign-off information which defines the management activity to be performed at the group of remote devices. The client device uses the sign off information to render a human-readable description of the management activity for presentation to the operator at step S103. In response to reading the description of the management activity, the operator of the client device may authorise the management activity to be performed at the group of remote devices at step S104. When approval of management activity is obtained, the method moves onto step S105, and a client signature is added to the authorised activity token resulting in a signed authorised activity token. The client signature may be added using a client private key under the control of the operator of the client device. The signed authorised activity token is then transferred to a group of remote devices. When approval of management activity is not obtained at step S104, then the method terminates at step S108, and an error message may be issued.

FIG. 2 illustrates a communication flow diagram of one implementation of the invention. A web service 40 is provided for managing a group of remote devices 50. The remote devices 50 may be Internet of Things (IoT) devices. The device(s) 50 are owned by a client, who may be an individual or a company etc. The client's device 10 is provided remote from the web service 40 and interacts with the web service 40 via the browser 20 over the Internet to manage the IoT device(s) 50. In addition, a hardware security module (HSM) 30 is provided to sign management activities for transmission to the IoT device(s) 50, following authentication of the operator of the client device 10 at the HSM.

The HSM may be an integral component of the client device 10 which is being used to access the web service 40 or may be an external device that attaches to the client device 10, for example via the Universal Serial Bus (USB) interface. The HSM may be a reader and security token, such as a card reader and smartcard, a USB dongle that contains a SIM card or Secure Digital card inside the USB dongle etc. The HSM may utilise a Time-based One-Time Password algorithm (TOTP) that computes a one-time password from a shared secret key and the current time.

The HSM 30 enables an operator to provide authenticatable authorisation of management activities, by signing the authorisation of the management activities without the operator needing to install additional software at the client device 10. HSM's are re-purposed such that existing ID mechanisms for signatures (PIN, fingerprint etc.) are used to authenticate the approval of device management decisions and provide end-to-end security. An operator approves a signature operation at an HSM by touching an HSM-controlled confirmation button, or by using their fingerprint on a fingerprint pad of the HSM to verify their physical presence at the time of approving the management activity to authenticate the approval of the management activity, or by performing a PIN entry on an external PIN pad to authenticate the approval of the management activity. This physical-presence feature of an HSM and/or the insertion of a PIN is used to authenticate an operators authorisation of a management activity by signing the management activity. The signing of the management activity may be combined with a secure time stamp controlled by a third party internet service.

Returning to FIG. 2, when a management activity, such as a firmware or software update, is required to be performed at the group of the IoT devices 50, the web service 40 sends a notification to the client device 10 at step S201, informing an operator of the client device 10 that a management activity is pending for the group of devices 50, or one or more of the devices of a specified class of the group. The operator of the client device 10 is the party empowered to authorise management activity requests for execution on the remote devices 50.

The operator responds by indicating that they wish to execute the management activity at step S202 and an authorisation request is sent to the web service 40 at step S203. The operator may be aware that a management activity is to be performed at the group of the remote devices without first receiving a notification from the web service 40 at step S201. In this instance, the communication flow begins at step S202 with the operator indicating that they wish to perform a management activity at the group of remote devices 50 and an authorisation request is sent to the web service 40 at step S203.

In order to perform the management activity at the IoT device(s) 50, the web service 40 requires the operator of the client device 10 to authorise the management activity. In addition, the web service 40 requires proof of the operators identity as owner/administrator 10 of the IoT device(s) 50, when authorising the management activity, prior to transmitting the authorised management activity to the IoT device(s) 50.

Following receipt of an authorisation request at step S203, the web service 40 transfers an activity authorisation token, that is required to be signed by the operator of the client device 10 to confirm the operators authorisation of the management activity, to the client device 10 at step S204.

The activity authorisation token comprises, at least, a digital signature of the web service which issued the authorisation request and machine-readable data. The machine-readable data comprising sign off information which defines the management activity to be performed at the IoT device(s) 50. The client device 10 uses the sign off information to render a human-readable description of the management activity to be approved by an operator of the remote client device 10 at step S205. When the operator has read the description of the management activity at step S205, the operator may authorise the update at step S206, for example by clicking “agree” or “OK”. In response to the operator approving the update, a request is transmitted to the HSM 30, which is provided at the client device 10, to generate a signature for application to the authorised management activity, at step S207. The HSM application programming interface (API) is modified to enable the HSM to sign the management activities.

WebAuthn (http://www.w3.org/TR/webauthn/) is an example of an API that can be used with a universal second factor (U2F) dongle such as (https://www.yubico.com/products/yubikey-hardware/fido-u2f-security-key/). Other examples of API's that can be used are: FIDO™ U2F; WebUSB; WebCrypto; Kerberos etc.

Two factor authentication is used to establish the identity of the operator authorising the update, such that the web service 40 can confirm that the update has been approved, and the identity of the operator approving the update, prior to transmitting the update to the IoT device(s) 50. The HSM 30 provides two factor authentication of the operator, without the operator being required to download any additional authentication software to the device 10 which they are using to access the web service 40. HSMs are supported by browsers and are exposed to browser-based software via the operating systems smart card APIs or may be accessed through Web USB APIs for Web USB compatible HSMs if required.

The HSM prepares and sends a request to the operator, requesting the operator proves their identity (the HSM requests user authentication) at steps S208 and S209. The operator enters their operator authentication at step S210. The HSM 30 uses the entered operator authentication to confirms the identity of the operator and releases the clients private key. The clients private key is used to add a client signature to the authorisation token at step S211. The signed token is transferred to the client device 10 together with a final request for confirmation that the update should be installed at steps S212 and S213.

The HSM stores a client private key and requires two factor authentication to release the client private key. When an operator has entered the correct operator authentication, the HSM allows usage of the client private key to add a client signature to the token, such that the authentication of the authorised token is controlled by the operator. The authorisation of the token can be tied back to the operator of the HSM. This also provides a clear audit trail to verify the identity of the operator authorising the management activity.

According to one embodiment, the operator is required to input a personal identification number (PIN) into the HSM to release the private key so that a client signature may be added to the activity authorisation token. According to another embodiment, the operator is required to present their fingerprint to the HSM, for the HSM to release the private key so that a client signature may be added to the activity authorisation token. According to another embodiment, the operator is required to press a button on the HSM to prove their physical presence and to confirm the signature operation, for the HSM to release the private key so that a client signature may be added to the activity authorisation token. The HSM may use a MAC (message authentication code) or a public/private-key signature to generate the client signature.

When the client confirms that the update should be installed at step S214, the signed activity authorisation token is transferred to the web service 40 at step S215.

The web service 40 that receives the signed activity authorisation token from the client device 10 at step S215, does not need to be the same web service 40 that sent the authorisation token to the client device at step S204.

The web service 40 optionally staples intermediate authorities of the received signed activity authorisation token at step S216 to establish an uninterrupted chain of certificates to the root of trust (RoT) and to check the RoT of the signed activity authorisation token. This prevents the remote IoT device 50 having to download missing/expired intermediate certificates to verify the certificate chain leading to the root of trust. The web service 40 reviews the intermediate certification authority(s) that are subordinate to the root certification authority as well as the root certification authority and validates the certificate of each intermediate certification authority up to the root certification authority.

When one (or more) certificate in the chain cannot be located or is found to be invalid the entire chain will be deemed invalid and the management activity will not be transmitted to the remote devices 50 at step S217. According to one embodiment, an error message may be displayed. When all of the certificates in the chain are validated, then the signed activity authorisation token is transferred to the remote device together with the management activity at step S217 and optionally the previously validated certificates stapled to the request.

The signed activity authorisation token should comprise both the client signature applied by the client device/HSM, and the web services signature applied to the original authorisation request. Therefore, the web service 40 may also optionally check at step S216 that the received signed activity authorisation token comprises both signatures as well as each signatures valid root of trust. Checking the web services signature applied to the original authorisation request, prevents an operator from making up requests for signing in the browser by manipulating the client/browser code. The web service signature prevents tampering by the operator or client/browser-based malware.

When a signed activity authorisation token does not comprise both the client signature and the web services signature, the management activity will not be transmitted to the remote devices 50 at step S217. According to one embodiment, an error message may be displayed. When a signed activity authorisation token does comprise both the client signature and the web services signature, and both signatures have valid root of trusts, then the signed activity authorisation token is transferred to the remote device together with the management activity at step S217.

The remote device(s) 50 may also optionally check the RoT of the signed activity authorisation token to verify the token at step S218 prior to processing the management activity at the remote device. The remote device validates the certificates of the authentication of the management activity, the authorisation of the management activity, and each intermediate certification authority up to the root certification authority. Therefore, the remote device 50 is able to authenticate both the remote client device 10 and the remote web service 40 by confirming the chain of trust before processing the management activity.

The remote device(s) 50 may also optionally check, at step S218, that the received signed activity authorisation token comprises both the client signature and the web services signature, as well as each signature's valid root of trust.

If the remote device(s) 50 is unable to verify the signed activity authorisation token, then the method is terminated, the signed activity authorisation token is not processed at the remote device 50, and an error message may be displayed

The signed authorisation of the management activity verifies that the management activity has been approved by a legitimate operator who is permitted to authorise the management activity and that the identity of the operator has been authenticated by verifying whether the certificate chain of the operator leads to an authorized root of trust known to the device 50.

FIG. 2 assumes that there is trust established between the web service 40 and the client device 10. However, a malicious attacker could get between the web service 40 and the browser 20, and manipulate the authorisation request sent from the web service 40 to the operator at the client device 10, such that the operator may think they are being ask to authorise a management activity when in fact they are being asked to authorise a different activity at the remote devices 50.

In order to establish trust in the web service 40, a static signing web application page targeting the web service 40, which requires an operator of the client device to authorise a management activity may be saved in the browser 20, or may be stored locally at the client device 10, for example as a Hypertext Markup Language (HTML) document. When the operator is required to authorise a management activity, the signing page may be executed from its saved location, rather than downloaded from the web service 40.

The signing web page may be saved in the browser 20 as an executable Javascript bookmarklet comprising a Uniform Resource Locator (URL) of the web page of the web service 40 together with an extension containing secure information, or a hash of the content that is expected at the URL and the secure information. An example of the secure information may be details of the management activity to be performed (i.e. the authorisation token), details regarding the identity of the remote devices to which the management activity is to be transferred etc. A Request for Comments (RFC) document regarding URL hashing may be found at https://tools.ietf.org/html/rfc6920. When the operator is required to authorise a management activity, the signing page may be generated and verified from the bookmarklet, the web page is opened from the URL and the secure information saved in the browser 20, is inserted into the appropriate areas of the web page. The operator may then authorise all resources subsequently loaded by the bookmarklet.

The bookmarklet is not required to store the web page of the web service 40 and instead saves only the secure information together with an anchor defining placement of the secure information in the web page, such that the secure information is used to populate part(s) of the web page retrieved using the URL.

By saving the signing page in the browser, or locally, or a secure hash of the signing page in the bookmarklet or a bookmark, a third party is prevented from manipulating the secure information of the web page and misleading the operator into authorising and signing an activity which is not genuinely from the web service 40.

FIG. 3 illustrates an exemplary communication flow for saving and utilising a signing web page. The web service 40 sends a web page (a signing page) which requires an operator of the client device to authorise a management activity to the browser 20 at step S301. The operator at the client device consents to the signing page being saved at step S302, and the signing page is stored at the browser at step S303. This is the only time the operator is required to trust the web service 40. As stated above, the signing page may be stored as a bookmarklet of the web service web page in the browser 20, the bookmarklet containing a URL for the web page and an extension or hash of the secure information such as the authorisation token which is to be inserted into the web page when generated. A period of time may then pass. The web service sends a notification to the client device that a management activity is pending at step S304. The operator then initiates the signing page at step S305 which loads the web service web page from the bookmarklet at step S306, such that the web page loads from the URL, but the secure information such as the authorisation token and sign off information is loaded from the stored extension or hash into the web page, preventing a third party from manipulating the request from the web service. The process of FIG. 3, then continues from step S206 of FIG. 2.

By saving a signing web page of the web service 40 to the browser 20 or locally at the client device 10, or a secure hash of the signing page in the bookmarklet or bookmark, the operator is provided with greater control of the management activities and in particular the security of the management activities. Trust is moved from the web service 40 to the operator who controls the IoT device(s) 50 providing a paradigm shift in authentication. Currently, the internet is based on participant authenticity, i.e. if the operator is communicating with the correct web service, then the data provided by the web service is assumed to be correct. In contrast, by storing the signing page as a bookmarklet of the web service web page, the method of FIG. 3 is utilising content authenticity, i.e. the operator validates that the content provided by the web service is correct rather than validating the identity of the web service providing the content.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the clients device, partly on the clients device and partly on a remote service computer or entirely on the remote service computer. In the latter scenario, the remote service computer may be connected to the clients device through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, the preferred embodiment of the present techniques may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present techniques.

As will be appreciated from the foregoing specification, techniques are described providing a computer implemented method for delivering an authenticatable management activity to a group of remote devices.

In embodiments the activity authorisation token comprises a digital signature of the remote service and machine-readable data, the machine-readable data comprising sign off information.

In embodiments, the method further comprises: prior to receiving the activity authorisation token, receiving, at the remote web client, a notification of a pending management activity to be performed on the group of remote devices; and transmitting to the remote service, a request for the pending management activity.

In embodiments, the method further comprises: storing the remote client private key in a hardware security module at the remote web client.

In embodiments, the method further comprises: utilising two factor authentication to release the remote client private key.

In embodiments, the method further comprises: prior to adding the client signature to the activity authorisation token, requesting the operator provides operator authentication to release the remote client private key; and generating the client signature based on the remote client private key.

In embodiments, the operator authentication comprises a personal identification number (PIN).

In embodiments, the operator authentication comprises the operators fingerprint.

In embodiments, the operator authentication comprises the operator providing proof of physical presence.

In embodiments, the method further comprises: forwarding the signed token to the remote service for transmittal to the group of remote devices.

In embodiments, the method further comprises: forwarding the signed token to another remote service for transmittal to the group of remote devices.

In embodiments, the method further comprises: establishing, at the remote service, a root of trust of the signed token, prior to transmittal to the group of remote devices.

In embodiments, the method further comprises: authenticating, at the remote service, the digital signature of the signed activity authorisation token and the client signature of the signed activity authorisation token, prior to forwarding the signed token.

In embodiments, the method further comprises: forwarding, from the remote service, the management activity together with the signed token to the group of remote devices.

In embodiments, the method further comprises: establishing, at the remote device, a root of trust of the signed token, prior to performing the management activity at the remote device.

In embodiments, the method further comprises: authenticating, at the remote device, both the remote web client and the remote service by confirming the one or more roots of trust of the signed token referred by one or more digital signatures attached to the token, prior to performing the management activity at the remote device.

In embodiments, the method further comprises: authenticating, at the remote device, the digital signature of the signed activity authorisation token and the client signature of the signed activity authorisation token, prior to performing the management activity at the remote device.

In embodiments, the group of remote devices comprises one or more remote devices.

Techniques are also described providing a computer implemented method for establishing trust in a remote service.

In embodiments, the signing web page comprises an executable Javascript bookmarklet, the bookmarklet comprising a Uniform Resource Locator of the web page of the remote service and the activity authorisation token; and wherein executing the signing web page comprises generating the signing web page from the Uniform Resource Locator and inserting the activity authorisation token into the generated web page and authorising all subsequently loaded resources by the bookmarklet.

In embodiments, the signing web page comprises a hash of the content that is expected at the Uniform Resource Locator of the web page of the remote service and a hash the activity authorisation token.

In embodiments, storing the signing web page for the remote service comprises storing a hash of the signing web page in a bookmarklet.

In embodiments, storing the signing web page for the remote service comprises storing a hash of the signing web page in a bookmark URL.

Techniques are also described providing a computer implemented method of repurposing a hardware security module to apply a client signature to an activity authorisation token.

In embodiments, the operator authentication comprises a personal identification number.

In embodiments, the operator authentication comprises the operators fingerprint.

In embodiments, the operator authentication comprises the operator providing proof of physical presence.

1. A computer implemented method for delivering an authenticatable management activity to a group of remote devices, the method comprising:
receiving, at a remote web client, an activity authorisation token from a remote service, the activity authorisation token defining a management activity to be performed on the group of remote devices;
rendering, at the remote web client, a human-readable description of the management activity to be approved by an operator of the remote web client; in response to approval of the management activity by the operator, adding, at the remote web client, a client signature to the activity authorisation token with a remote web client private key under the control of the operator; and
forwarding, from the remote web client, the signed activity authorisation token to enable the signed token to be provided to the group of remote devices.

2. The computer implemented method of claim 1, wherein the activity authorisation token comprises a digital signature of the remote service and machine-readable data, the machine-readable data comprising sign off information.

3. The computer implemented method of claim 1, further comprising:
prior to receiving the activity authorisation token, receiving, at the remote web client, a notification of a pending management activity to be performed on the group of remote devices; and
transmitting to the remote service, a request for the pending management activity.

4. The computer implemented method of claim 1, further comprising:
storing the remote client private key in a hardware security module at the remote web client.

5. The computer implemented method of claim 4, further comprising:
utilising two factor authentication to release the remote client private key.

6. The computer implemented method of claim 5, further comprising:
prior to adding the client signature to the activity authorisation token, requesting the operator provides operator authentication to release the remote client private key; and
generating the client signature based on the remote client private key.

7. The computer implemented method of claim 6, wherein the operator authentication comprises the operator providing proof of physical presence, a personal identification number or a fingerprint of the operator.

8-9. (canceled)

10. The computer implemented method of claim 1, further comprising:
forwarding the signed activity authorisation token to the remote service for transmittal to the group of remote devices; or
forwarding the signed activity authorisation token to another remote service for transmittal to the group of remote devices.

11. (canceled)

12. The computer implemented method of claim 10, further comprising:
establishing, at the remote service, a root of trust of the signed activity authorisation token, prior to transmittal to the group of remote devices.

13. The computer implemented method of claim 2, further comprising:
authenticating, at the remote service, the digital signature of the signed activity authorisation token and the client signature of the signed activity authorisation token, prior to forwarding the signed token.

14. The computer implemented method of claim 10, further comprising:
forwarding, from the remote service, the management activity together with the signed activity authorisation token to the group of remote devices.

15. The computer implemented method of claim 14, further comprising:
establishing, at one or more of the remote devices, a root of trust of the signed activity authorisation token, prior to performing the management activity at the one or more remote device.

16. The computer implemented method of claim 15, further comprising:
authenticating, at one or more of the remote devices, both the remote web client and the remote service by confirming the one or more roots of trust of the signed activity authorisation token referred by one or more digital signatures attached to the token, prior to performing the management activity at the one or more remote device.

17. The computer implemented method of claim 14, further comprising:
authenticating, at one or more of the remote devices, the digital signature of the signed activity authorisation token and the client signature of the signed activity authorisation token, prior to performing the management activity at the one or more remote device.

18. The computer implemented method of claim 1, wherein the group of remote devices comprises one or more remote devices.

19. A computer implemented method for establishing trust in a remote service, the method comprising:
storing locally, at a browser, a static signing web application page targeting the remote service; and
executing the signing web application page, the signing web application page comprising an activity authorisation token defining a management activity provided by the remote service for client authorisation to be performed on a group of remote devices.

20. The computer implemented method of claim 19, wherein the signing web application page comprises an executable Javascript bookmarklet, the bookmarklet comprising a Uniform Resource Locator of the web page of the remote service and the activity authorisation token; and wherein executing the signing web application page comprises generating the signing web application page from the Uniform Resource Locator and inserting the activity authorisation token into the generated web page and authorising all subsequently loaded resources by the bookmarklet.

21. The computer implemented method of claim 20, wherein the signing web application page comprises a hash of the content that is expected at the Uniform Resource Locator of the web page of the remote service and a hash the activity authorisation token.

22. The computer implemented method of claim 20, wherein storing the signing web application page for the remote service comprises storing a hash of the signing web application page in a bookmarklet.

23. (canceled)

24. A computer implemented method of controlling a hardware security module to apply a client signature to an activity authorisation token, the activity authorisation token defining a management activity to be performed on a group of remote devices, the method comprising:
storing a client private key in the hardware security module;
in response to an operator approving the management activity, requesting the operator provides operator authentication to release the client private key; generating the client signature based on the client private key; and applying the client signature to the approved activity authorisation token.

25-29. (canceled)
